(19) United States
(12) Patent Application Publication
(10) Pub. No.: US 2002/0179158 A1
(43) Pub. Date: Dec. 5, 2002

(54) Automatic transmission torque converter-clutch regulator valve

(76) Inventor: Robert C. Warnke, Salem, WI (US)

Correspondence Address: STEPHEN E. FELDMAN, P.C., 12 East 41st Street, New York, NY, 10017, US

(21) Appl. No.: 09/873,981

(22) Filed: Jun. 4, 2001

(51) Int. Cl. G05D 16/00

(52) U.S. Cl. 137/596

(57) ABSTRACT

The present invention relates to automatic transmissions of land motor vehicles. In particular the present invention refers to the field of automatic transmission torque converter clutch regulator valves. The present invention comprises of a first spool valve, a second spool valve that attaches to the first spool valve, a sleeve valve that attaches to the second spool valve and an end plug that is placed on the sleeve valve. The valve assembly controls the volume supplied to the apply circuit. The present invention limits both apply and release pressure circuit. The valves of the present invention fit into existing bores and control both circuits. The switch valve prevents main line drop during apply circuit regulation.

### FIELD OF INVENTION

The present invention relates to automatic transmissions of land motor vehicles. In particular the present invention refers to the field of automatic transmission torque converter clutch regulator valves. The present invention uses an apply circuit, a release circuit and a switch valve. A switch valve controls the volume supplied to the apply circuit. The present invention's regulator limits both apply and release pressure circuit. The valves of the present invention fit into existing bores and control both circuits. The switch valve prevents main line drop during apply circuit regulation.

### BACKGROUND OF THE INVENTION

There are several apparatuses in the field of the present invention that are conventionally well known. The present technology presently available is described below in detail. There are several problems that are associated with the present technology for the clutch converter valves. The present invention solves such problems by introducing innovations making the present invention of superior quality as compared with the prior art technology. Following is a description of prior art that may be useful to one skilled in the art.

U.S. Pat. No. 4,548,238 to Chorkey is directed to directional control valve with straight through flow. This prior art is a reversing, four-way, two-position fluid directional control valve having a valve body with an enclosed chamber therein and at least two oppositely disposed sides. Two outlet ports are formed through one of the two sides, and they communicate with the chamber, and an inlet port is fanned through the other of the two sides and it communicates with the chamber. At least one exhaust or fluid return port communicates the chamber to the exterior of the valve body. A slider valve element means is mounted in the chamber and it is movable between two operating positions, for providing a straight through fluid flow path through the valve body, from the inlet port to a selected one of the outlet ports. The outlet ports exhaust through the chamber and at least one exhaust or fluid return port. The present invention comprises of a switch valve that controls the volume supplied to an apply circuit. Furthermore, the present invention has a regulator that limits both apply and release pressure circuits. Finally, the present invention's valves fit in already existing bores and the switch valve prevents main line drop during regulation of the apply circuit. The purpose of the present invention is to prevent automatic transmission converter lock-up piston deflection.

U.S. Pat. No. 4,587,887 to Shibayama et al. teaches a shift valve for automatic transmission. A shift valve for an automatic transmission wherein governor pressure acts on a spool in such a direction as to compress a first spring, and throttle representative pressure acts on a plug in such a direction as to compress the first spring. The shift control valve further comprises a second spring arranged to act on the spool in the same direction as the direction in which the governor pressure acts on the spool. The present invention is a switch valve, which controls a volume that is supplied to an apply circuit in an automatic transmission of a land motor vehicle. The present invention further comprises a regulator that limits both apply and release pressure circuits. Finally, the present invention's valves fit in already existing bores and the switch valve prevents main line drop during regulation of the apply circuit. The purpose of the present invention is to prevent automatic transmission converter lock-up piston deflection

U.S. Pat. No. 5,768,953 to Younger discloses a method and a system for improving the operation of transmissions for motor vehicles. This prior art modifies the original hydraulic fluid circuits of the automotive transmission provided by the automobile manufacturer to enable the transmission to manually select any available ratio at any time, to select first gear at any time, and to enable the transmission to produce quick applies during upshifts and fast releases during downshifts for improved performance and heavy duty use with only minimum ratio sharing or overlap during gear changes. The modification of the original automotive transmission to achieve goals includes adjustment of the hydraulic fluid circuits by providing a new 1-2 shift valve, by providing new hydraulic flow circuits, by discontinuing use of existing hydraulic circuits, by enlarging the size of preexisting orifices and by plugging other orifices, and by adjusting preexisting spring and pressure values; all of which adjust the fluid flow and operation of the original factory installed automotive transmission in accordance with the basic objectives of this prior art. The present invention is a switch valve, which controls a volume that is supplied to an apply circuit in an automatic transmission of a land motor vehicle. A regulator limits both apply and release pressure circuits. Finally, the present invention's valves fit in already existing bores and the switch valve prevents main line drop during regulation of the apply circuit. The purpose of the present invention is to prevent automatic transmission converter lock-up piston deflection

The discussed prior art presents a formidable database of information. However, this prior art does not attempt to solve the problems that the present invention is designed to answer. The present invention is a torque converter-clutch regulator valve for an automatic transmission of a land motor vehicle that prevents high wear and tear when used under normal operational conditions of a land motor vehicle transmission. Furthermore, the present invention controls pressure that is supplied to an apply circuit in the transmission. It further prevents converter lock-up and piston deflection.

It should be clear to one skilled in the art, that the above discussed prior art is used for the purposes of illustration and should not be construed as limiting in any way, except for the prior art elements claimed in the above patents.

### SUMMARY OF THE INVENTION

The object of the present invention is to provide for a torque converter-clutch regulator valve in the automatic transmission of a land motor vehicle.

Another object of the present invention is provide for a torque converter-clutch regulator valve having, a switch valve that controls the volume that is supplied to the apply circuit of am automatic transmission of a land motor vehicle.

Another object of the present invention is to provide for a torque converter-clutch regulator valve having a regulator that limits the apply and the release pressure circuits in an automatic transmission of a land motor vehicle.

Another object of the present invention is to provide for a torque converter-clutch regulator valve that fits into existing bores of an automatic transmission of a land motor vehicle.

Another object of the present invention is to provide for a torque converter-clutch regulator valve that prevents main line drop during apply circuit regulation in an automatic transmission of a land motor vehicle.

Other objects of the present invention will become apparent from the foregoing description. It should be understood by one skilled in the art that the terms and identifications used by the applicant should not be interpreted as limiting the invention to a particular embodiment or object described above. Only the prior described above contains possible limitations to the present invention.

### BRIEF DESCRIPTION OF THE DRAWINGS

The following description of preferred embodiment of the present invention will be better understood when read in conjunction with the appended drawings. It should be understood, however, that the invention is not limited to the precise arrangements shown in which:

FIG. 1 is a blown up view of the present invention assembly showing a first spool valve, a second spool valve, a sleeve valve and an end plug.

FIG. 2 is a plain view of the present invention assembly's first spool valve.

FIG. 3 is a plain view of the present invention assembly's second spool valve.

FIG. 4 is a plain view of the present invention assembly's sleeve valve.

FIG. 5 is a plain view of the present invention assembly's end plug.

### DESCRIPTION OF THE PREFERRED EMBODIMENT

The present invention relates to a field of automatic transmissions of land motor vehicles. The present invention would be better understood in conjunction with a following description of a preferred embodiment. However, it is understood by one skilled in the art that the present invention is not limited to the above referenced specific embodiment, but other embodiments are allowable, provided they are within the scope and spirit of the following claims.

In the following description, references to the drawings, certain terms are used for conciseness, clarity and comprehension. It is assumed by one skilled in the art that there are to be no unnecessary limitations implied from the such references, besides the limitations imposed by the prior art, because such terms and references are used for descriptive purposes only and intended to be broadly construed. Furthermore, the description and the drawings are for illustrative purposes only and not to be construed as limited to the exact details shown, depicted, represented, or described.

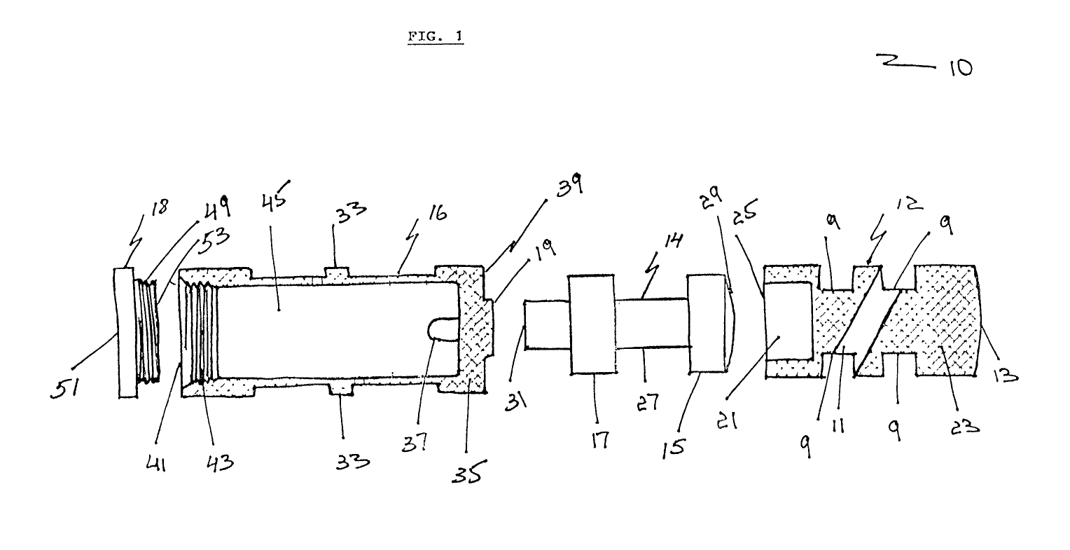

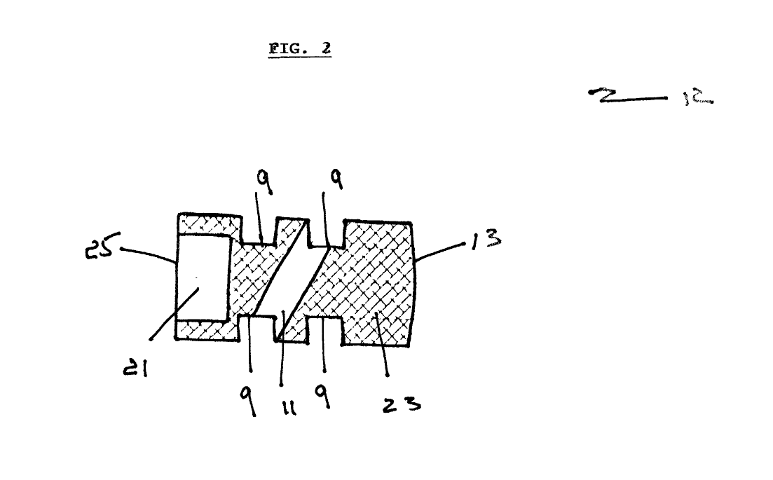

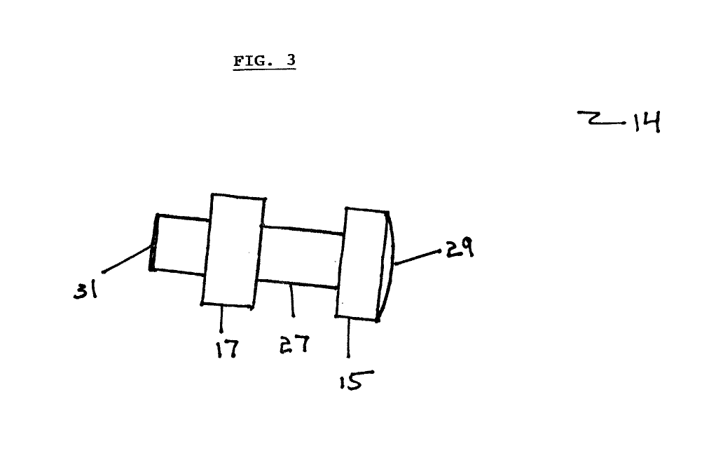

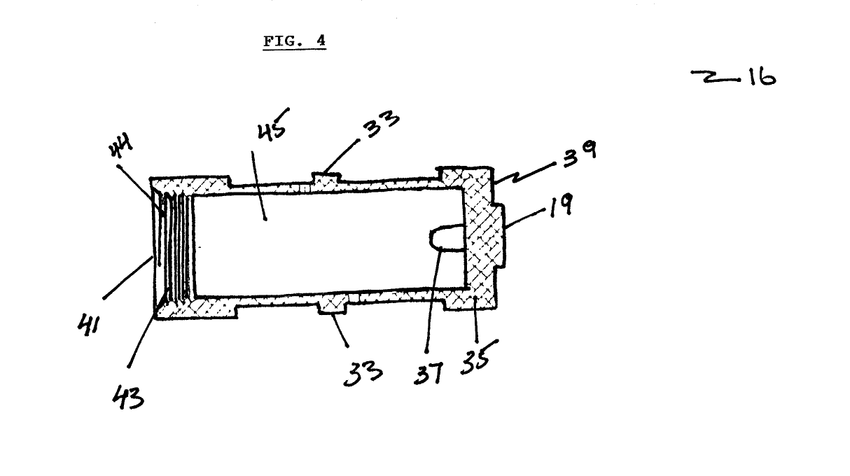

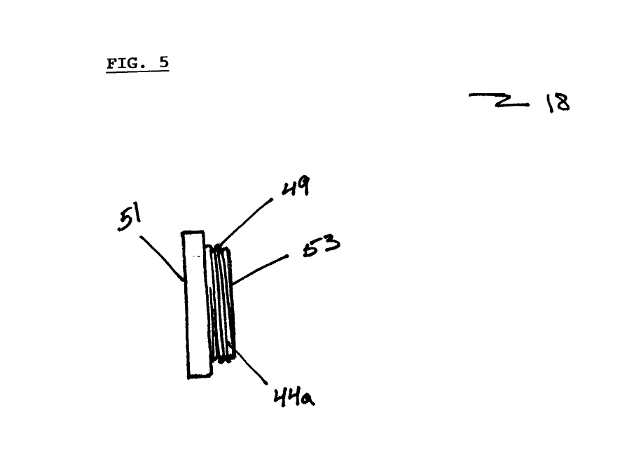

Referring to FIG. 1, the present invention is shown in blown up form. The assembly 10 comprises of a first spool valve 12, more specifically described in conjunction with FIG. 2, a second spool valve 14, more specifically described in conjunction with FIG. 3, a sleeve valve 16, more specifically described in conjunction with FIG. 4, and an end plug, more specifically described in conjunction with FIG. 5. Referring to FIG. 2, the assembly 10's first spool valve 12 is shown. The first spool valve has a front portion 13 and a back portion 25. The front portion 13 has a rounded shape. The back portion 25 has an opening 21 that serves to receive the second spool valve 14. The first spool valve has a body 23, which may be fabricated from any conventional metals that are suitable for proper operation of the assembly 10. In valve 12's body 23, a channel 11 is diagonally cut through, wherein the channel 11 serves to relieve some amounts of pressure during the assembly 10 operation. Furthermore, the body 23 of the valve 12 has grooves 9. Grooves 9 have a function of accommodating the placement of the assembly 10 into already existing bores of the automatic transmission.

Referring to FIG. 3, a second spool valve 14 is shown. The second spool 14 has a front portion 29 and a back portion 31. The front portion 29 has a rounded shape and a back portion 31 has a flat shape. The second spool valve 14 has a shaft 27 on which holding portions 17 and 15 are mounted and upon placement of a valve into the automatic transmission, fit into the existing bores of such transmission. The front portion 29 of the second spool valve 14 fit into the back portion 25 of the first spool valve 12, as shown in FIG. 1.

Referring to FIG. 4, a sleeve valve 16 is shown. The sleeve valve 16 has a front portion 39 and a back portion 41. The back portion 39 has a grooved section 19 that attaches to the back portion 31 of the second spool valve 14. The sleeve valve 16's back portion 41 has a threaded portion 43 having a plurality of threads 44 that are capable of interaction with end plug 18's threads 44a. The sleeve valve 16 has a sleeve 45 that is located inside sleeve valve's body 35. Furthermore, the sleeve valve 16 has grooved portions 33 that are located on the sides of the sleeve valve 16. The grooved portions 33 serve to adjust the sleeve valve 16 into the already existing bores of the automatic transmission circuits.

Referring to FIG. 5, an end plug 18 is shown. The end plug 18 has a front portion 53 and a back portion 51. The front portion 53 attaches to the back portion 41 of sleeve valve 16. The front portion 53 has a threaded section 49 that contains threads 44a that come in contact with threads 44 of the sleeve valve 16.

The assembly 10's first spool valve 12, second spool valve 14, sleeve valve 16 and an end plug 18 may be fabricated from any conventionally known metals that are capable of withstanding the amount of pressure and wear and tear required for the operation of the assembly 10. The assembly 10 serves to limit the pressure of the apply and release circuit of the automatic transmission of a land motor vehicle. Furthermore, the assembly 10 serves to prevent transmission piston's deflection and reduction of a volume supplied to the above circuits.

In the foregoing description of the invention, reference to the drawings, certain terms, have been used for clarity, conciseness and comprehension. However, no unnecessary limitations are to be implied from or because of the terms used, beyond the requirements of the prior art, because such terms are used for descriptive purposes and are intended to be broadly construed. Furthermore, the description and illustration of the invention are by way of example, and the scope of the invention is not limited to the exact details shown, represented, or described.

While the present invention has been described with reference to specific embodiments, it is understood that the invention is not limited but rather includes any and all changes and modifications thereto which would be apparent to those skilled in the art and which come within the spirit and scope of the appended claims.

What is claimed:

1. A torque converter-clutch regulator valve for the automatic transmission of a land motor vehicle comprising
a. a first spool valve further comprising
i. a rounded front portion;
ii. a back portion;
iii. a pressure reduction channel;
iv. grooved portions;
b. a second spool valve adjacent to the first spool valve further comprising
i. a rounded front portion that attaches to said first spool valve's back portion;
c. a sleeve valve adjacent to the second spool valve further comprising
i. a grooved front portion that attaches to said second spool valve's back portion;
ii. a sleeve located inside said sleeve valve;
iii. a threaded back portion;
d. an end plug further comprising
i. a threaded front portion that attaches to said sleeve valve's threaded end portion.

2. The torque converter-clutch regulator valve of claim 1, wherein said sleeve valve's threaded back portion further comprises a plurality of threads.

3. The torque converter-clutch regulator valve of claim 1, wherein said end plug's threaded front portion further comprises a plurality of threads.

4. The torque converter-clutch regulator valve of claim 1, wherein said pressure reduction channel of said first spool valve is cut diagonally across said first spool valve.

5. The torque converter-clutch regulator valve of claim 1, wherein said grooved portions of said first spool valve serve as a means for placing said torque converter-clutch regulator valve.

6. The torque converter-clutch regulator valve of claim 1, wherein said first spool valve may be fabricated from any conventionally known metals.

7. The torque converter-clutch regulator valve of claim 1, wherein said second spool valve may be fabricated from any conventionally known metals.

8. The torque converter-clutch regulator valve of claim 1, wherein said sleeve valve may be fabricated from any conventionally known metals.

9. A torque converter-clutch regulator valve for the automatic transmission of a land motor vehicle comprising
a. a first spool valve further comprising
i. a rounded front portion;
ii. a back portion;
iii. a pressure reduction channel cut diagonally across said first spool valve;
iv. grooved portions that serve as a means for placing said torque converter-clutch regulator valve;
b. a second spool valve adjacent to the first spool valve further comprising
i. a rounded front portion that attaches to said first spool valves back portion;
c. a sleeve valve adjacent to the second spool valve further comprising
i. a grooved front portion that attaches to said second spool valve's back portion;
ii. a sleeve located inside said sleeve valve;
iii. a threaded back portion further comprising a plurality of threads;
d. an end plug further comprising
i. a threaded front portion that attaches to said sleeve valve's threaded end portion further comprising a plurality of threads.

10. The torque converter-clutch regulator valve of claim 9, wherein said first spool valve may be fabricated from any conventionally known metals.

11. The torque converter-clutch regulator valve of claim 9, wherein said second spool valve may be fabricated from any conventionally known metals.

12. The torque converter-clutch regulator valve of claim 9, wherein said sleeve valve may be fabricated from any conventionally known metals.
